(19) United States
(12) Patent Application Publication
(10) Pub. No.: US 2014/0203124 A1
(43) Pub. Date: Jul. 24, 2014

(54) MOVABLE SHREDDER FOR METAL MATERIALS

(71) Applicant: TALLERES ZB, S.A., Renteria (Guipuzcoa) (ES)

(72) Inventor: Jose Angel ARRIETA GONZALEZ, RENTERIA (Guipuzcoa) (ES)

(21) Appl. No.: 13/908,301

(22) Filed: Jun. 3, 2013

(30) Foreign Application Priority Data
Jan. 23, 2013 (ES) P201330074

(51) Int. Cl. B02C 21/02

(52) U.S. Cl. CPC B02C 21/02
USPC 241/79; 241/101.71

(57) ABSTRACT

The invention is a movable shredder for metal materials that comprises a movable assembly (1) and a drive unit (2), so that the movable assembly (1) shreds the metal material into fragments by means of a shredding element (7), and the drive unit (2) supplies energy to the movable assembly (1), said energy is used by the shredding element (7) to shred said metal material into fragments, wherein comprises a frame (3) and a system of caterpillar tracks (4) which make the movable assembly (1) movable. The movable assembly (1) comprises a feeding conveyor belt (11), a dosing roller (6), the shredding element (7), a metal extraction conveyor belt (8) and an outgoing conveyor belt (9).

### OBJECT OF THE INVENTION

The present invention relates to a machine that shreds different types of metal waste into fragments, which is successful in achieving a shredding quality similar to that of stationary facilities and has the feature of being movable.

### TECHNICAL PROBLEM TO BE SOLVED AND BACKGROUND OF THE INVENTION

The entire industry devoted to the collection, treatment and recycling of all types of materials has undergone great developments in the last years, especially in highly developed countries, mainly due to the increasing awareness of environmental issues, namely in the context of limited resources.

This recovering awareness leads to an increasing demand for specific procedures and machinery to solve the problems generated by the recovery of a particular material.

There are also legal regulations, like the ELV Directive of the European Union 2000/53/CE (ELV: end of life vehicles), which establishes an 85% recycling target for end of life vehicles, mandatory as for 2015. From 2015 on, this ratio might even increase to 95%.

The difficulty of recovering materials is increased considerably when the material intended to be recovered is mixed with other types of materials from which it has to be separated, as is usually the case.

Thus, the first objective of a method for recovering materials is separating properly the different materials, and preparing said materials once they have been separated for their reuse.

The objective is to generate clean products from one single material, out of this very complex flux of materials, using the proper separation procedures. This is worthwhile since the processing not only preserves the natural resources constituting raw materials, but it is also considerably less expensive when compared with, for instance, the production of aluminum for obtaining primary raw materials, since using secondary materials saves approximately a 90% of the energy demand.

Among the methods for recovering materials, and at the forefront of the recovery and/or recycling industry of materials, the recovery of end of life vehicles, whose steel can be reused in foundries, is a method that has been in operation for several decades.

So far, this recovery method of end of life vehicles has been carried out in plants or stationary facilities.

However, there are vehicle recovery centers, which are not equipped with the resources necessary for installing a fixed plant and nevertheless, they could afford the installation of equipment that could process vehicles and were movable.

The main problems encountered so the equipment can carry out the shredding with the same quality than a stationary plant are, in addition to its ability to be moved, the weight and dimensions of the equipment itself.

### DESCRIPTION OF THE INVENTION

To avoid the aforementioned drawbacks and to achieve the aimed targets, the movable shredder of the invention, comprises a movable assembly and a drive unit. The movable assembly shreds the metal material into fragments by means of a shredding element. The drive unit supplies energy to the movable assembly being said energy used by the shredding element to carry out the shredding of said metal material. The movable assembly comprises a frame and a system of caterpillar tracks which makes the movable assembly movable.

In the movable shredder for metal material, the movable assembly comprises a feeding conveyor belt, a dosing roller, a shredding element, a metal extraction conveyor belt and an outgoing conveyor belt.

All the aforementioned elements are fastened to the frame and the feeding conveyor belt transports the metal material to an entrance ramp for metal material, through which the metal material reaches the dosing roller.

The dosing roller regulates the entry of the metal material into the shredding element that shreds the metal material into fragments, which once shredded, comes out the shredding element by means of the outgoing conveyor belt.

The material reaches the outgoing conveyor belt from the metal extracting conveyor belt that receives the fragments of material directly from the shredding element.

The feeding conveyor belt comprises metal plates that drag the metal material via the feeding conveyor belt in motion towards the entrance ramp.

The dosing roller is attached to the frame of the movable assembly, by means of a fastening and guiding system, which comprises at least four guides and two hydraulic cylinders that control the vertical motion of the dosing roller.

The shredding element of the movable shredder comprises a shredding mill, a shredding chamber, a closed lower base, a vertical exit grid for shredded material, a horizontal exit grid for shredded material and an exit gate for non-shreddable material.

In the movable shredder object of the invention, the metal material enters the shredding chamber, where the metal material is shredded into fragments by the shredding mill, in such a way that the material that has already been shredded, comes out through the vertical exit grid for shredded material and through the horizontal exit grid for shredded material, and, if there is any non-shreddable material, it comes out through the exit gate for non-shreddable material.

The movable assembly of the movable shredder for metal material comprises metal sheets forming in first place a cover for said feeding system that aside from covering the feeding system also direct the metal material towards the shredding element, and also forming a reception hopper for material.

The metal sheets, together with the feeding conveyor belt and the entrance ramp guide the metal material introduced by said reception hopper until the dosing roller.

### DESCRIPTION OF THE FIGURES

To complete the description and for a better understanding of the features of the invention, a set of figures have been attached to this specification as an integral part thereof, wherein in an illustrative rather than limitative manner the following has been represented:

FIG. 1 shows a sectional view of the movable assembly that makes part of the movable shredder.

FIG. 2 shows a perspective view of the movable shredder object of the invention.

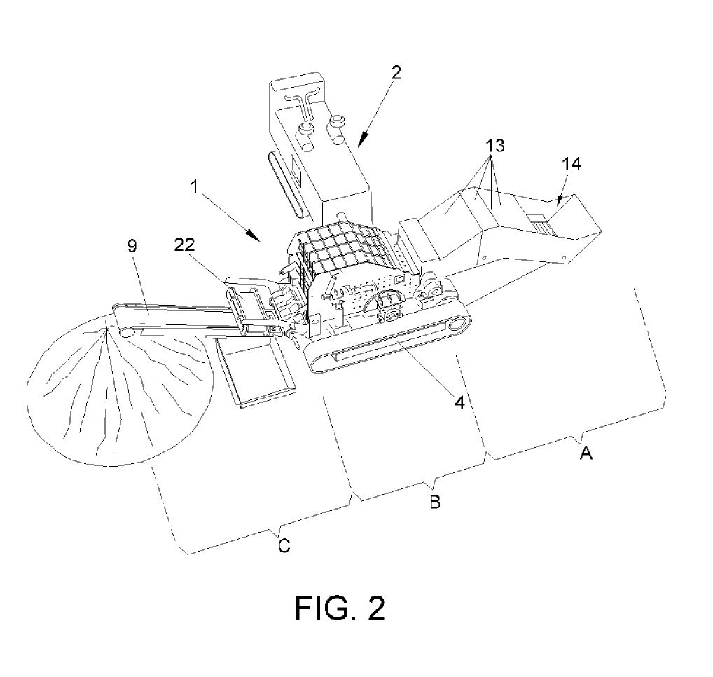

The references of the figures represent the following elements:
A.—waste feeding area,
B.—waste treatment area,
C.—waste extraction area,
1.—movable assembly,
2.—drive unit,
3.—frame,
4.—system of caterpillar tracks,
5.—feeding system,
6.—dosing roller,
7.—shredding element,
8.—metal extraction conveyor belt,
9.—outgoing conveyor belt,
10.—metal plates,
11.—feeding conveyor belt,
12.—lattice,
13.—metal sheets,
14.—reception hopper,
15.—exit gate for non-shreddable material,
16a.—vertical exit grid for shredded material,
16b.—horizontal exit grid for shredded material,
17.—guides for the dosing roller,
18.—hydraulic cylinders,
19.—shredding chamber,
20.—closed base,
21.—entrance ramp,
22.—band conveyor belt,
23.—shredding mill.

### Description of a Preferred Embodiment

The invention, subject matter of the present patent application, is a shredder that comprises two independent elements working together: a movable assembly (1) and a drive unit (2), the drive unit (2) being in charge of supplying energy to the movable assembly (1).

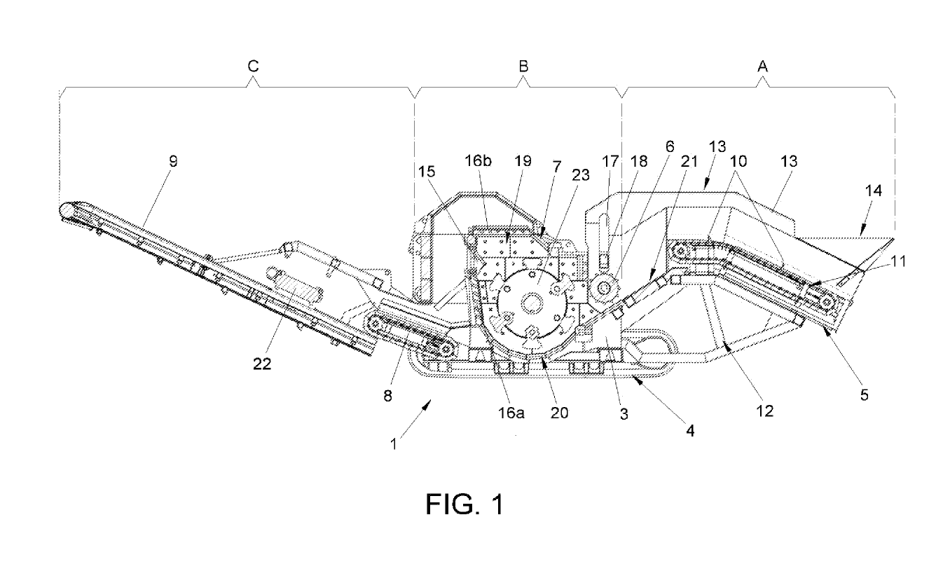

The movable assembly (1) (whose sectional view can be observed in FIG. 1) comprises a frame (3) and a system of caterpillar tracks (4) which provides the movable assembly (1) with the feature of the mobility.

The remaining components of said movable assembly (1) are placed on the frame (3) of the movable assembly (1). Among the remaining components are the following:
a feeding system (5),
a dosing roller (6),
a shredding element (7),
a metal extraction conveyor belt (8), and
an outgoing conveyor belt (9) of shredded material.

The movable assembly (1) of the movable shredder, subject matter of the invention, in regard to this specification, is divided into three areas:
waste feeding area (A),
waste treatment area (B),
waste extraction area (C).

The feeding system (5) that comprises several metal plates (10) attached to a metal feeding conveyor belt (11) supported on a lattice (12) is located in the waste feeding area (A) and, following the path along which the material to be treated travels, next there is a material entrance ramp (21).

The feeding conveyor belt (11) has such a shape that the extremity of the feeding conveyor belt (11) located in the farthest portion of the treatment area (B) is positioned at a height such that the material load is carried out easily. The feeding conveyor belt (11) is provided with a first upward section ending in a horizontal section.

In a preferred embodiment of the invention, the shredding element (7) is a hammer mill.

The waste feeding system (5) is covered with metal sheets (13), which make up a metal cover for said feeding system (5) and a reception hopper (14) for material located in the farthest portion of the treatment area (B), said metal sheets (13) together with the feeding conveyor belt (11) guide the incoming waste materials introduced by said reception hopper (14).

Following the path along which the waste materials travel within the movable assembly (1), at the treatment area (B) entrance a dosing roller (6) is located. Before said waste materials come into the shredding element (7), by means of the dosing roller (6) the size and quantity of material entering the shredding element (7) are monitored, thus avoiding the entry of large elements that could block the shredding element (7).

The dosing roller (6) is attached to the frame (3) by means of a fastening and guiding system, which comprises at least, four guides (17) and two hydraulic cylinders (18) that control the vertical motion of the dosing roller (6).

The shredding element (7) comprises:
a shredding chamber (19) smaller in size than the shredding chambers of conventional hammer mills,
a shredding mill (23),
a lower closed base (20) unlike the conventional hammer mills that incorporate an lower exit grid for material,
an vertical exit grid for shredded material (16a),
an horizontal exit grid for shredded material (16b),
an exit gate for non-shreddable material (15),

The material, which cannot be shredded into fragments or that is not coming out through the exit grids for shredded material (16a, 16b) comes out through the exit gate for non-shreddable material (15).

By means of the shredding element (7), high-density fragments of material are obtained.

Finally, in the waste extraction area (C), a metal extraction conveyor belt (8) collecting the fragments of material is located. Said metal extraction conveyor belt (8), besides absorbing the impacts of the shredded material, raises said shredded material up to the outgoing conveyor belt (9), which is made of conventional rubber.

The outgoing conveyor belt (9) raises the fragments of material in order to accumulate them into a stockpile of material already treated.

Finally, in the waste extraction area (C), the movable assembly (1) comprises a ferrous separation system and a dust removal system, which are already known in the state of the art.

The ferrous separation system comprises a band conveyor belt (22) located on the outgoing material conveyor belt (9), said band conveyor belt (22) comprises a continuous magnet to which the ferrous material sticks, in such a way that the ferrous fragments are conveyed with the movement of the band conveyor belt (22).

The invention should not be limited to the particular embodiment that has been described in this document. Any person skilled in the art may develop other embodiments in view of the description hereby disclosed. Consequently, the scope of the invention is defined by the following claims. CLAIMS

1. A movable shredder for metal material wherein the movable shredder comprises a movable assembly and a drive unit, so that the movable assembly shreds the metal material into fragments by means of a shredding element, and the drive unit supplies energy to the movable assembly being said energy used by the shredding element to shred said metal material, with the movable assembly comprising a frame and a system of caterpillar tracks which makes the movable assembly movable.

2. The movable shredder for metal materials, according to claim 1, wherein the movable assembly comprises:
a feeding conveyor belt,
a dosing roller,
the shredding element,
a metal extraction conveyor belt, and
an outgoing conveyor belt,
all the aforementioned elements are fastened to the frame and the feeding conveyor belt transports the metal material to an entrance ramp whereby the metal material reaches the dosing roller that regulates the metal material being fed into the shredding element that shreds the metal material into fragments, which once shredded, comes out of the shredding element feeding the metal extraction conveyor belt that in turn feeds the outgoing conveyor belt.

3. The movable shredder for metal material, according to claim 2, characterized in that the feeding conveyor belt comprises metal plates that drag the metal material via the feeding conveyor belt in motion, towards an entrance ramp for metal material.

4. The movable shredder for metal material, according to claim 2, characterized in that the dosing roller is attached to the frame of the movable assembly by means of a fastening and guiding system, which comprises at least four guides and two hydraulic cylinders that control a vertical motion of the dosing roller.

5. The movable shredder for metal material, according to claim 1, wherein the shredding element comprises:
a shredding mill,
a shredding chamber,
a closed lower base,
a vertical exit grid for shredded material,
a horizontal exit grid for shredded material,
an exit gate for non-shreddable material,
so the metal material enters the shredding chamber, where it is shredded into fragments by the shredding mill, in such a way that the material that has already been shredded, comes out through the vertical exit grid for shredded material and through the horizontal exit grid for shredded material and, the non-shreddable material comes out through the exit gate for non-shreddable material.

6. The movable shredder for metal material, according to claim 1, wherein the movable assembly comprises metal sheets that make up:
a cover for the feeding system that aside from covering the feeding system also drive the metal material towards the shredding element, and
a material reception hopper,
therefore the metal sheets, together with the feeding conveyor belt and the entrance ramp guide the metal material introduced by the material reception hopper until reaching the dosing roller.

7. The movable shredder for metal material, according to claim 2, wherein the shredding element comprises:
a shredding mill,
a shredding chamber,
a closed lower base,
a vertical exit grid for shredded material,
a horizontal exit grid for shredded material,
an exit gate for non-shreddable material,
so the metal material enters the shredding chamber, where it is shredded into fragments by the shredding mill, in such a way that the material that has already been shredded, comes out through the vertical exit grid for shredded material and through the horizontal exit grid for shredded material and, the non-shreddable material comes out through the exit gate for non-shreddable material.

8. The movable shredder for metal material, according to claim 2, wherein the movable assembly comprises metal sheets that make up:
a cover for the feeding system that aside from covering the feeding system also drive the metal material towards the shredding element, and
a material reception hopper,
therefore the metal sheets, together with the feeding conveyor belt and the entrance ramp guide the metal material introduced by the material reception hopper until reaching the dosing roller.
